(19) United States
(12) Patent Application Publication
(10) Pub. No.: US 2001/0008193 A1
(43) Pub. Date: Jul. 19, 2001

(54) Cladding element

(75) Inventors: Jurgen Moitzheim, Konigswinter (DE); Jorg Bantel, Overath (DE)

Correspondence Address: AKIN, GUMP, STRAUSS, HAUER & FELD, L.L.P., ONE COMMERCE SQUARE, 2005 MARKET STREET, SUITE 2200, PHILADELPHIA, PA, 19103, US

(73) Assignee: Kautex Textron GmbH & Co. KG

(21) Appl. No.: 09/760,114

(22) Filed: Jan. 12, 2001

(30) Foreign Application Priority Data
Jan. 19, 2000 (DE) 100 01 932.3

(51) Int. Cl. G10K 11/04

(52) U.S. Cl. 181/200; 181/198

(57) ABSTRACT

A cladding element having sound-absorbent properties is provided for screening an engine and/or exhaust system of a motor vehicle, for example as an underbody cover panel for same, in the form of a substantially plate-shaped, self-supporting stiff component of thermoplastic material formed at least in part as a hollow body, which at least partially accommodates a sound-absorbent filling of foamed thermoplastic material.

### BACKGROUND OF THE INVENTION

The present invention generally concerns a cladding element and more particularly a cladding element for use in a motor vehicle for sound-absorption purposes.

Endeavours are increasingly being made in relation to modem motor vehicles to reduce the level of noise emitted by the engine and/or the exhaust system, by cladding the components which may be involved directly or indirectly with the production of noise, for example and more specifically by lining the engine compartment with sound-absorbent material. By way of example, mention may be made in this respect of insulating elements consisting of closed-cell foam material or felt or fleece-like material, of a non-woven structure, for such purposes. Reference may be made in this respect to German published patent application DE 198 48 679 A1, disclosing an insulating element involving a layered or laminate structure comprising felt or fleece-like material and an enclosure for same comprising layers of film or sheet material. Reference may also be made to German published patent application DE 198 48 677 A1, disclosing a similar insulating element. Those materials comprise a relatively complicated composite of three-dimensional and two-dimensional textile materials as well as foils or sheets and/or foam materials.

Another form of insulating element comprises sound-absorbent plates, which define structures affording what can be referred to as cavity resonators. Attention may be directed, by way of example, in this respect to German Patent DE 25 15 127 C2, describing a sound-absorbent plate with groups of adjacent cavity resonators of constant cross-section and of different lengths, whose acoustically open ends are disposed in mutually juxtaposed relationship and form sound-entry openings for the cavity resonators. Such cavity resonators are generally in the form of elements of a comparatively complex internal structure in order to provide for sound absorption of the utmost effectiveness. The production of such sound absorber elements from tubular components is correspondingly complicated and expensive.

Reference may also be made to German published patent application DE 197 30 922 A1, disclosing such a sound absorber arrangement having tubular elements with their longitudinal axes arranged in mutually crossing relationship or extending at an incline with respect thereto. Such an assembly may be in the form of an engine mounting element, a wire housing, the tail pipe of an exhaust system or part of an engine air intake assembly. Finally, it is also provided that this sound absorber arrangement can be disposed at the underside of an engine hood. In terms of the mode of operation of this sound absorber, in a similar manner to the above-described sound absorber, which involves the provision of cavity resonators, an important factor is that it is sound-transmissive and air-permeable. A design configuration which is thus proposed for that purpose, for example, involves the provision of a loose fill of tubular elements in a retaining bag comprising a sound-transmissive and/or air-permeable woven or knitted fabric. It will be noted, however, that the production of such a sound absorber also appears to be comparatively expensive.

### BRIEF SUMMARY OF THE INVENTION

An object of the present invention is to provide a cladding element for screening an engine and/or an exhaust system of a motor vehicle, which is comparatively simple and inexpensive to produce and which can be comparatively easily installed in a motor vehicle.

A further object of the invention is to provide a cladding element for use in a motor vehicle for sound-absorption purposes, which can afford an at least satisfactory sound-absorption effect while being of a generally lightweight nature.

Still another object of the present invention is to provide a sound-absorbent cladding element for use in relation to an internal combustion engine and more specifically in the context of a motor vehicle which affords enhanced versatility of use while being of a simple structure.

In accordance with the principles of the present invention, the foregoing and other objects are attained by a cladding element having sound-absorbent properties for screening or shielding an engine and/or an exhaust system of a motor vehicle, in the form of a generally plate-shaped, self-supportingly stiff component of thermoplastic material. The component is formed at least in part as a hollow body, which at least partially accommodates a sound-absorbent filling of foamed thermoplastic material.

It will be noted that such a cladding element can be comparatively easily produced, for example from polypropylene or glass fiber-reinforced polypropylene, such material also being comparatively heat-resistant, so that the cladding element can possibly also be used as a heat shield if desired.

In accordance with a preferred feature of the invention, the cladding element can be produced, for example, by extrusion blow molding. In that case, the filling of foamed thermoplastic material can be introduced during the blow molding procedure, or it can be subsequently introduced into the hollow body.

In accordance with another preferred feature of the invention, the hollow space or cavity defined by the hollow body of the cladding element accommodates a foamed thermoplastic material in the form of plastic beads, which were introduced into the internal cavity of the hollow body under pressure, with a concomitant increase in volume subsequent to introduction thereof. When such an operating procedure is adopted, firstly the external configuration of the cladding element is produced in conventional manner by the blow molding process.

After the expansion step, possibly already commencing in the last phase thereof, a multiplicity of plastic beads of foam material is blown or injected into the hollow body while it is still disposed in the blow molding mold. The commencement of that injection operation depends in substance on the pressure conditions obtaining in the hollow body. In general, it will be desirable for the blowing pressure, which obtains within the hollow body expanded from the blow molding preform and which can be, for example between 10 and 12 bars, to be firstly reduced so that then the plastic beads can be injected into the internal cavity in the hollow body under a comparatively low working pressure, for example of between 2 and 4 bars.

The above-mentioned small plastic beads, which preferably comprise closed-cell plastic material, have previously been put under an increased pressure so that they have accordingly experienced a noticeable reduction in volume. The hollow body, while disposed in the blow molding mold, is filled with the plastic beads as completely as possible so that, after the internal cavity defined within the hollow body has been completely relieved of pressure therein, the plastic beads experience a relaxation effect and thus a corresponding expansion effect with an increase in volume which generally provides that even regions which have not yet been filled in the internal cavity of the hollow body are then also filled by the foam of the plastic beads.

The increase in volume of the plastic beads can have the result that the hollow body is permanently under a certain degree of increased internal pressure, although this does not represent any problem. On the contrary, it has been found that it is possible, by adopting the above-discussed operating procedure, to arrive at a closed uniform foam filling within the hollow body, without any necessity for the plastic beads to be joined together by means of welding, adhesive or in some other fashion.

It will be noted that it is possible for the plastic beads which bear against the internal wall surface of the hollow body, defining the internal cavity therein, to be welded thereto, more particularly if the plastic beads and the external material of the cladding element are constituted by the same or compatible materials. An option which presents itself in this respect is, for example, to make the plastic beads from polypropylene. Cavities in the cladding element which are filled in that way enjoy excellent sound-barrier properties.

In a further preferred feature of the invention, the cavity in the hollow body is subdivided into a plurality of sub-volumes of generally box-shaped configuration so that it is possible to impart the desired inherent stiffness to the cladding element by virtue of a suitable configuration thereof.

In order to make manufacture of the cladding element by extrusion blow molding easier and also in order to be able to expand the component as uniformly as possible, while having to provide the minimum number of expansion holes, a preferred feature of the invention provides that the above-mentioned sub-volumes of the internal cavity in the hollow body communicate with each other by way of suitable passages.

Preferably, at least some of the generally box-shaped cavities defined in the hollow body may be bordered by stiffening cavities of small volume, the depth thereof being less than the depth of the generally box-shaped sub-volumes defined within the cladding element. The stiffening cavities can also be filled with foamed thermoplastic material.

Preferably, the cladding element also includes stiffening ribs, which are formed by welding wall portions of the component, between the above-mentioned stiffening cavities.

In accordance with a further preferred feature of the invention, the cladding element may also comprise a peripherally extending edge or border region in which the walls of the cladding element are pressed flat against each other or welded flat to each other. That makes it unnecessary to produce a welded seam in the blow molding process in the conventional fashion. Consequently, in comparison with a conventional extrusion blow molding process for producing hollow bodies, the two mold portions of the molding tool used in the operating procedure of the invention involve the application of lower levels of closing force, as it is only necessary for the edges of the component to be squeezed off.

The inherent stiffness achieved by virtue of the geometry of the cladding element according to the invention, as referred to hereinbefore, makes it possible for the cladding element to be in the form of an underbody cover panel for a motor vehicle. It will be appreciated that such an underbody cover panel not only ensures an excellent sound-proofing action, but also the drag coefficient or Cd factor of a motor vehicle equipped with such an underbody cover panel is also markedly improved, as air turbulence in the engine compartment or bay which is open to the road or at exposed parts of the underbody assembly of the vehicle can be at least considerably reduced. Such air turbulence can also give rise to noise which can thus be reduced in association with the improvement in drag coefficient.

In a further preferred feature of the invention, a cladding element has at least at one side, more specifically at the side which is to be fitted towards the vehicle, a topography which is defined by the cavity arrangement and which at least approximately corresponds to the underbody profile of the motor vehicle to which the cladding element is to be fitted.

Furthermore, in another preferred feature of the invention, at least one air passage can be provided in the cladding element in such a way as to pass therethrough, for example to provide a flow of air to an air cooler or like piece of equipment.

Further objects, features and advantages of the invention will be apparent from the description hereinafter of a preferred embodiment of the invention.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there is shown in the drawings an embodiment which is presently preferred. It should be understood, however, that the invention is not limited to the precise arrangements and instrumentalities shown. In the drawings:

FIG. 1 is a plan view of a cladding element according to the invention in the form of an underbody cover panel for a motor vehicle, as viewed from the side which is towards the underbody of the motor vehicle;

FIG. 2 is a view in section taken along line II-II in FIG. 1; and

FIG. 3 is a schematic view of an apparatus for producing cladding elements filled with foam material, including a blow molding mold in an open condition.

### DETAILED DESCRIPTION OF THE INVENTION

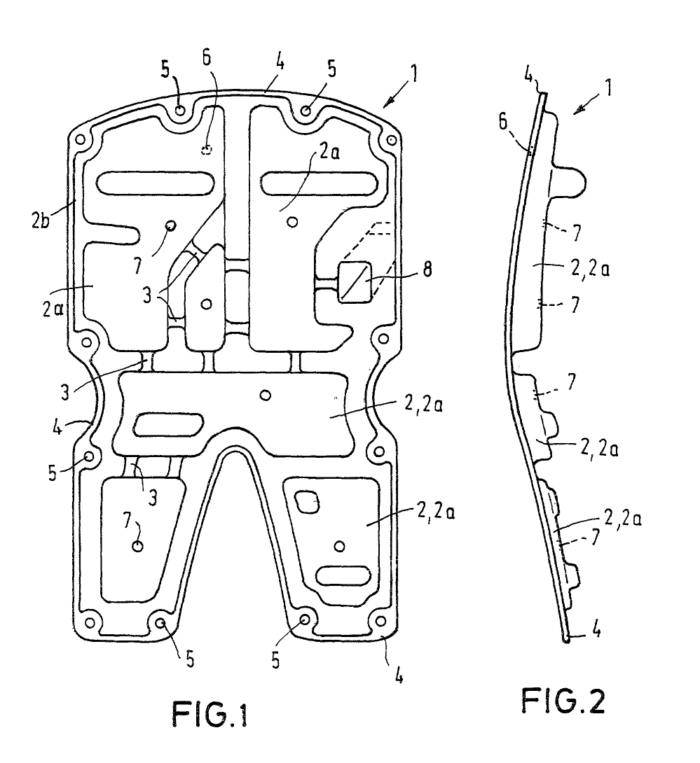

Referring first to FIG. 1, shown therein is a cladding element 1 having sound-absorbent properties for screening, for example, at least an engine and/or exhaust system of a motor vehicle, in the form of a substantially plate-shaped, self-supportingly stiff component of thermoplastic material. The illustrated cladding element 1 is shown in the form of an underbody cover panel for a motor vehicle, and is thus intended to screen or shield the engine and at least parts of the exhaust system of the vehicle from noise emissions. The illustrated embodiment of the cladding element 1 is also intended to serve at the same time to improve the aerodynamic drag coefficient or Cd factor of a motor vehicle.

It will be noted, however, that the invention is to be interpreted in broad terms, insofar as a cladding element according to the invention may also be disposed at other points on a motor vehicle, for example at the underside of an engine hood or between an engine compartment or bay and the passenger compartment or cell. It will be appreciated, therefore, that the specific illustrated configuration of the cladding element 1 according to the invention is only set forth by way of example in terms of being adapted to the particular situation of use as an underbody cover panel. It will also be noted accordingly that the geometry of the cladding element 1, as described hereinafter, is only by way of example and may be varied as desired according to the respective use for which the cladding element is intended.

The cladding element 1 in the form of the substantially plate-shaped, self-supportingly rigid component comprises a suitable thermoplastic material, for example and preferably glass fiber-reinforced polypropylene, with a glass fiber addition of between 5 and 15%. The reference to self-supportingly rigid in accordance with the invention is intended to mean that the cladding element enjoys the necessary inherent stiffness such that it can be mounted for example in unsupported or cantilevered relationship at the underbody of a motor vehicle without involving additional support or stabilization.

As is readily apparent from reference to FIGS. 1 and 2 in combination, the cladding element 1 is in the form of a double-wall component defining a plurality of internal cavities 2 therein, which are in communication with each other by way of suitable passages diagrammatically indicated at 3 in FIG. 1. The cavities 2 thus form a general cavity or internal space within the cladding element 1.

The cavities 2 form various sub-volumes in the cladding element 1, which is thus in the form of a hollow body. Cavities 2a of a generally box-shaped configuration essentially determine the topography of the cladding element 1, at the side thereof which in the fitted position is towards the underbody surface of the motor vehicle. On the side of the cladding element, which in the mounted condition faces away from the underbody surface of the motor vehicle, the cladding element in the illustrated embodiment is of a generally smooth configuration.

The cavities 2a of a generally box-shaped configuration are, without exception, filled with a closed-cell foam material in the form of mini-beads of polypropylene of comparatively low density. The density of the foam is selected in accordance with the desired sound-barrier properties of the cladding element 1 and it can be for example between 20 and 30 grams per liter.

The cavities 2a of generally box-shaped configuration are edged or bordered by stiffening cavities 2b, which are each of a smaller volume and which for example may be between 1 and 3 mm in height, with a wall thickness of the walls of the cladding element 1 being about 1 mm. The depth of the stiffening cavities 2b is also less than that of the cavities 2a, as will be seen hereinafter.

The stiffening cavities 2b may also be filled with thermoplastic foam in the form of mini-beads, to a greater or lesser degree, depending on the respective pressure under which the mini-beads are introduced into the cavities 2b, although this filling is not absolutely necessary. In order to ensure that the cavities 2a are filled with mini-beads without gaps and spaces therein, the cavities 2a communicate with each other by way of the passages 3, whose height is markedly more than 3 mm and can possibly correspond to the height of the respective cavities 2a. The height of the cavities 2a may vary between 30 mm and about 100 mm, depending on the respective profile of the motor vehicle underbody for which the cladding element 1 is intended.

At locations, the walls of the cladding element can be welded entirely to each other, for example in the form of a peripherally extending edge or border as can be clearly seen from FIG. 1, or in the form of a pressed edge portion, wherein the width of the edge or border 4 can be between about 3 and 10 mm. A weld of that kind can also be provided in the region of fixing holes as identified by reference numeral 5 in FIG. 1 for mounting the cladding element 1 in place, for example to the underbody structure of the motor vehicle.

Reference numeral 6 in FIGS. 1 and 2 denotes a blowing expansion hole, through which at least one needle of a diameter of about 2 to 8 mm can be inserted during the blow molding procedure to expand and inflate the preform produced in the initial stage of the process for producing the cladding element, as will be described hereinafter.

Reference numeral 7 in FIGS. 1 and 2 denotes filling holes provided at the respective cavities 2a, for introducing the mini-beads thereinto.

Finally, the cladding element also includes at least one air passage diagrammatically indicated at 8 in FIG. 1, which passes entirely through the cladding element 1 and which can serve for example to provide a feed flow of air to a radiator or air cooler or other item of equipment which requires air to be fed thereto.

For the sake of completeness at this point, it should also be mentioned that the walls of the cladding element 1 are pressed and welded to each other in the region of the fixing holes 5 and in the region of the edge or border portion 4, but welds may also be provided at any location of the cladding element 1 for reinforcing purposes.

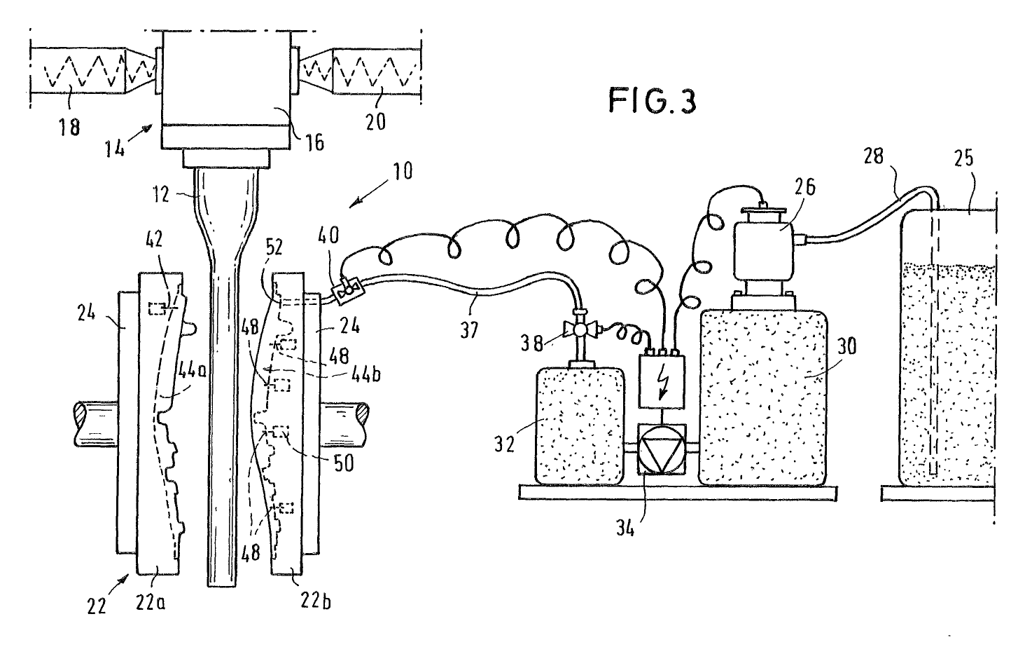

Reference will now be made to FIG. 3, which diagrammatically shows an extrusion blow molding apparatus 10, by means of which a process for producing the cladding element 1 according to the invention will now be described.

Looking therefore at FIG. 3, the illustrated extrusion blow molding apparatus 10 includes an extrusion unit 14 which serves to produce tubular preforms as indicated at 12. Of the extrusion unit 14, FIG. 3 only shows an extrusion head 16 and, on a greatly reduced scale, first and second extruders 18 and 20. The use of two extruders in that way makes it possible to produce a preform 12 whose wall is of a laminate structure comprising two layers. It will be self-evident that it is also possible to provide just a single layer or more than two layers for the preform 12, depending on the respective design configuration of the extrusion unit 14.

Reference numeral 22 generally indicates a two-part blow molding mold. In the illustrated embodiment, the blow molding mold 22 is arranged beneath the extrusion head 16 in such a way that it can receive the preform 12 which is extruded therefrom and which hangs freely down from the extrusion head 16. The blow molding mold 22 comprises first and second mold portions 22a and 22b, which are shown in an open position in FIG. 3 and which are movable towards each other in the plane of FIG. 3 into a closed position (not shown) in which they co-operate to define the appropriately shaped mold cavity therein.

Reference numeral 24 denotes respective mounting plates, which carry the mold portions 22a and 22b of the blow molding mold 22.

Arranged at a spacing from the blow molding mold 22 is a supply container 25 for plastic beads, from which the plastic beads are conveyed into an intermediate container 30 disposed therebeside, by means of a suitable conveyor device 26, by way of a conduit or hose 28. The intermediate container 30, like the supply container 25, is under normal pressure.

A pressure container 32 is connected to the intermediate container 30 by way of a pump diagrammatically indicated at reference 34. The pump 34 conveys the plastic beads out of the intermediate container 30 into the pressure container 32. At the same time, they build up therein an increased pressure which can be, for example, 2 bars and which at any event must be higher than the pressure which prevails in the interior of the blow molding mold 22 or in the hollow body disposed in the blow molding mold, which hollow body has been produced in the mold by expansion of the preform 12 by blow molding thereof.

Connected to the pressure chamber 32 is a pipe or conduit 37 provided with first and second valves 38 and 40. The hose or conduit 37 terminates within the mold portion 22b and at that end, as indicated at 52, it is of such a configuration that the interior of the hollow body to be produced from the preform in the mold cavity of the mold 22 can be communicated with the conduit 37 and thus with the pressure container 32.

As already mentioned above, the hollow body, with a generally plate-shaped configuration thereof, is produced in the usual fashion in such a manner that first a tube is extruded as the preform 12, into which two bars (not shown) are introduced from below. The bars are moved away from each other at least approximately parallel to the plane of division of the blow molding mold 22, and in so doing they spread the tubular preform 12 to put it into a substantially flat condition. Support air is also already being introduced into the preform 12 through the extrusion head 16 in the usual fashion. Thereafter, the blow molding mold 22 is closed by movement of the mold portions 22a and 22b towards each other, with excess material being squeezed off along the whole or virtually the whole periphery of the spread preform 12. In this case the two spreading bars are disposed outside the contour of the mold cavity and thus the squeeze edges provided on the mold portions for delimiting the edges of the mold cavity.

After the mold 22 is closed by the movement of the mold portions 22a, 22b into their closed position, the preform 12 is expanded by expansion air being introduced through a blowing nozzle 42 into the preform. The contour of the hollow body which is produced in that case is determined by the contour of the mold cavity which is composed of the two mold cavity portions indicated at 44a and 44b in the mold portions 22a and 22b respectively. The operation of introducing blowing air 42 can under some circumstances already be implemented during closure of the blow molding mold. It will be appreciated, however, that these involve procedures which are familiar to any person skilled in the field of blow molding. A corresponding consideration also applies in regard to the extrusion procedure for production of the preform 12. For that purpose, details in relation to such procedures will not be further set forth herein.

It may be noted at this point that the process described herein for producing a hollow body in the form of a bumper for motor vehicles is already described in DE 199 30 903 to which reference is directed here to incorporate the appropriate disclosure thereof.

Along the vertical extent of the mold cavity 44a and 44b and thus along the hollow body which is disposed therein, the mold portion 22b is provided with hollow needles which are diagrammatically indicated at 48 and which project beyond the boundary of the mold cavity portion 44b into same so that, at the latest upon expansion of the preform 12, the wall thereof is pierced by the hollow needles 48 in the region of the cavities indicated at 2a in FIG. 1. Each of the hollow needles 48 is connected to a reduced pressure source (not shown), with the interposition of a valve of which one is indicated at 50.

The procedure more specifically is such that, after the blow molding mold 22 is closed, the preform 12 experiences expansion thereof to form the hollow body therein. As soon as the expansion procedure is terminated or shortly thereafter, the pressure is reduced in the internal space in the hollow body, which during the expansion operation can be, for example, about 10 bars. That can be effected by way of the blowing nozzle 42 or by way of a venting opening provided thereat, but possibly also by way of the hollow needles 48 whose valves 50 have been closed during the expansion procedure. The extent to which the internal pressure in the hollow body formed from the preform 12 is reduced essentially depends on the pressure under which the plastic beads are transported from the pressure container 32 into the internal space in the hollow body. At any event, the pressure in the pressure container 32 must be greater. In that respect, with an increasing pressure difference between the pressure in the pressure container 32 and the pressure in the interior of the hollow body, the speed at which the plastic beads are transported into the interior of the hollow body is also increased. The pressure in the interior of the hollow body, and thus in the blow molding mold 22, must be sufficiently high to provide that the plastic beads experience a certain compression effect, with a reduction in the volume which they assume under normal pressure. In the process as described above, the box-like cavities 2a of the cladding element are filled simultaneously or in a given sequence with the plastic beads, and possibly, and this also depends on the pressure in the pressure container 32, the stiffening cavities 2b may optionally also be filled with plastic beads.

An increased pressure is maintained within the hollow body formed from the preform 12, up to the end of the filling operation for introducing the plastic beads. The increased pressure within the hollow body is sufficient to hold the plastic beads in a compressed condition so that, after termination of the filling operation, the plastic beads can expand within a short period between the interior of the hollow body and the external enclosure for same.

It will be appreciated that the process as described above is in itself not subject-matter of the present invention, although it should also be pointed out at this juncture that the filling within the hollow body, by virtue of the increase in volume of the individual plastic beads after complete pressure equalization has occurred, experiences a compacting and consolidating effect resulting in a uniform foam structure whose individual particles, however, are not actually totally joined together.

It will be appreciated that the above-described cladding element according to the invention, and the operating procedure for the production thereof, have been set forth solely by way of example and illustrations of the principles thereof and that various other modifications and alterations may be made therein without thereby departing from the spirit and scope of the invention as defined by the appended claims.

We claim:

1. A cladding element having sound-absorbent properties for screening at least one of an engine and an exhaust system of a motor vehicle, comprising a substantially plate-shaped, self-supportingly stiff component of thermoplastic material, which is formed at least in part as a hollow body with a cavity therein, and a sound-absorbent filling of foamed thermoplastic material at least partially accommodated in said cavity.

2. The cladding element according to claim 1, which is produced by extrusion blow molding.

3. The cladding element according to claim 1, wherein the foamed thermoplastic material accommodated in the cavity of the hollow body is in the form of plastic beads introduced into the cavity under pressure with concomitant increase in volume subsequent to introduction thereof.

4. The cladding element according to claim 1, wherein the cavity in the hollow body is subdivided into a plurality of sub-volumes of substantially box-shaped configuration.

5. The cladding element according to claim 4, further comprising passages interconnecting the sub-volumes.

6. The cladding element according to claim 4, wherein at least some of the sub-volumes are bordered by stiffening cavities of small volume having a depth which is less than a depth of the sub-volumes.

7. The cladding element according to claim 6, further comprising stiffening ribs formed by welding of wall portions of the component between the stiffening cavities.

8. The cladding element according to claim 1, comprising a peripherally extending border region in which walls of the component are pressed flat against each other.

9. The cladding element according to claim 1, comprising a peripherally extending border region in which walls of the component are welded flat to each other.

10. The cladding element according to claim 1, which is in a form of an underbody cover panel for a motor vehicle.

11. The cladding element according to claim 10, which has first and second sides and at least on one side has a topography defined by a cavity arrangement and which at least approximately corresponds to an underbody profile of a motor vehicle.

12. The cladding element according to claim 1, further comprising at least one air passage passing through the cladding element.

13. A cladding element having sound-absorbent properties for use on a motor vehicle, comprising a component of thermoplastic material and of generally flat configuration adapted to fit to a surface of the motor vehicle to which the cladding element is to be applied, the component comprising first and second walls disposed at a spacing from each other at least in a region-wise manner to define cavities within the component, and a sound-absorbent filling of foamed thermoplastic material accommodated in the cavities in a form of plastic beads in a condition of pressing against each other and against the walls of the component.
